(19) United States
(12) Patent Application Publication
(10) Pub. No.: US 2007/0224979 A1
(43) Pub. Date: Sep. 27, 2007

(54) Opt-in data communication to wireless devices

(75) Inventors: Shawn O'Neal, Santa Rosa Beach, FL (US); John Maier, Crystal Lake, IL (US)

Correspondence Address: GREENBERG TRAURIG, LLP, 77 WEST WACKER DRIVE, SUITE 2500, CHICAGO, IL, 60601-1732, US

(73) Assignee: iMAN, Inc.

(21) Appl. No.: 11/385,110

(22) Filed: Mar. 21, 2006

Related U.S. Application Data
(63) Continuation-in-part of application No. 10/561,659, filed on Jun. 26, 2006.

(51) Int. Cl. G06F 15/16; H04M 3/42

(52) U.S. Cl. 455/417

(57) ABSTRACT

A method and apparatus for providing opt-in data communications to a user of a wireless device such as a mobile telephone is provided. The user can call a telephone number associated with an interactive voice response unit, towards opting in to receipt of digital messaging, such as advertising or marketing material. In response, information captured during the telephone call can be used to prepare, format and transmit digital messaging to the user.

### CROSS-REFERENCE TO RELATED APPLICATIONS

This application is a continuation-in-part of applicant's co-pending U.S. application Ser. No. 10/561,659, filed Dec. 16, 2005 and titled Arrangement for Mobile Communications and Wireless Publishing, the disclosure of which is hereby incorporated by reference in its entirety.

### BACKGROUND OF THE DISCLOSURE

1. Field of the Invention

The present invention relates in general to transmission of wireless data communications, and specifically to a system by which users can opt-in to receipt of data communications, such as marketing or advertising materials, at a mobile telephone or other wireless device.

2. Background Art

In recent years, electronic messaging such as email has become a very popular medium for the transmission of information such as advertising and marketing materials. Compared with more traditional printed advertisements and mailings, electronic messaging typically provides a vastly decreased cost of distribution.

Meanwhile, portable wireless communication devices having digital messaging capabilities, such as email or text messaging, have become increasingly prevalent.

It would be desirable for many businesses to send communications, such as advertising and marketing materials, to users of portable wireless devices. However, users of wireless devices often incur charges based upon the volume of usage, such that users may possibly be subjected to increased charges by virtue of receiving such advertising and marketing messages. Some users may also find the receipt of certain communications at their wireless devices, particularly unsolicited communications, to be bothersome or objectionable. For this and other reasons, transmission of solicited and unsolicited commercial messaging to portable wireless devices is becoming increasingly regulated. As a result, businesses must often take steps to ensure that wireless message transmissions are sent only to recipients who have expressly authorized their transmission, i.e., to users who have “opted-in” to receipt of messages.

One approach to opt-in communications that can be used for the transmission of wireless advertisement involves the use of SMS transmissions directed to a “short code.” A short code is a number having fewer digits than a conventional 10-digit telephone number, to which an SMS or text message can be sent by customers of mobile telephone service providers. Participating wireless service providers will route SMS messages directed to the short code, to a system maintained by the lessor. The configuration and leasing of short codes can be individually negotiated with each wireless service provider.

A Common Short Code, or CSC, is a short code that is common across a variety of wireless service providers in the United States. A business will typically lease a CSC for a limited period of time from a central administrator who coordinates implementation of the CSC amongst various wireless service providers. The CSC can be selected by the lessor, or assigned arbitrarily. A CSC is sometime specified for its significance relative to an advertising or marketing campaign with which the CSC is associated. However, in the U.S., CSCs are limited to five digit numbers varying between 20000 and 99999.

For example, a shoe company may elect to rent a short code “74637”, corresponding to the letters “S-H-O-E-S” on a conventional telephone keypad, in connection with a promotion for a new line of shoes. The company can then advertisement in, for example, sporting goods stores, advising potential consumers to send a text message to “S-H-O-E-S” on their wireless phones to receive information on features of the company's new line of athletic shoes, as well as a digital coupon for a discount on a purchase. To the extent that the short code has been implemented by each consumer's wireless service provider, the consumer is able to send a text message to “74637” on their mobile phone, which is directed to a messaging system implemented by the sponsor shoe company. The consumer can thereby grant permission for the company to send marketing materials associated with the advertising campaign to which the consumer responded, directly to the consumer's cellular phone. Once the consumer “opts-in”, the company can transmit digital messaging containing advertising and marketing materials to the consumer.

However, typical short code implementations suffer several drawbacks. For example, it may be desirable to ensure that all users in a particular (potentially wide or even nationwide) geographical area are able to implement a given short code. However, because short codes are not directly routed through the public switched telephone network, but instead are processed locally by each wireless service provider, they must be implemented separately by each wireless service provider. Even when implemented by a CSC administrator, typically each service provider independently determines whether it will support each CSC and its intended application. Therefore, an advertiser's ability to reach the broadest array of users of wireless devices is typically up to the discretion of each wireless service provider. Also, leasing of a short code can be expensive, and is typically guaranteed only for a limited period of time.

In view of the above, it may be desirable to implement alternative opt-in systems for the transmission of messages such as marketing and advertisement materials to users of portable wireless devices. It may be further desirable to implement a system that may be readily and conveniently accessed by a user using his or her portable wireless device. It may also be desirable to provide a system that can be implemented by an advertiser quickly and inexpensively.

Once a user has elected to receive marketing or promotional messages on his or her wireless device, the messages must be transmitted. However, in some cases, such as marketing campaigns, messages must be transmitted to a number of different recipients, using a variety of different wireless devices with a variety of different wireless service providers. When digital messages are conveyed between a mobile telephone user, and another entity outside of the network operated by the mobile telephone user's service provider, such messages are typically conveyed using MIME (Multipurpose Internet Mail Extensions) formatting. The MIME format is intended to provide standard mechanisms for transmitting digital content. Thus, service providers typically provide a MIME server configured to translate digital messages between a service provider's designated formatting, and a format based upon MIME standards.

However, because MIME does not govern all aspects of formatting and content for digital messaging, and because wireless service providers may use varying MIME translations to and from their designated messaging protocols within their own networks, implementation of MIME does not ensure identical handling of digital messages by each wireless service provider. Thus, the formatting and content of digital messages can be altered or lost during conversion processes as messages are communicated to and from users on different networks.

Therefore, it would be desirable to provide a wireless messaging system capable of transmitting messages to users of multiple different wireless communication networks. It would further be desirable to ensure that formatting and content of such messaging is optimized for each user, regardless of the wireless network through which the messages are delivered. It would also be desirable to provide a powerful and flexible messaging platform capable of conveying potentially complex and interactive communications to users of wireless devices.

Some of these and other features may be provided through implementation of various aspects of the present invention.

### SUMMARY OF THE INVENTION

A method for transmitting digital messaging to a user of a wireless electronic device, such as a mobile telephone, is provided. A telephone call placed using a wireless device is received. A set of information associated with the wireless electronic device and/or the user is then captured. Following capture of the set of information, one or more digital messages are transmitted to the wireless electronic device.

The capture of information associated with the wireless electronic device may include the detection of a telephone number associated with the wireless electronic device using caller identification services. Information can also be captured by prompting the user for entry of a telephone number associated with the wireless electronic device, and detecting the telephone number entered by the user in response. The identity of the caller can be verified by capturing telephone numbers through both caller identification services and prompting of the user, such that the telephone number is not considered valid unless the number entered by the user corresponds to the number from which the call is placed. Additional information can also be captured during the telephone call from the wireless device, including demographic information such as the age and/or gender of the caller. The identity of the wireless service provider with which the wireless device is associated can also be captured.

The content of digital messages sent to the wireless device may depend upon the information captured during the telephone call. For example, the message content may depend upon demographic information captured during the telephone call, such that wireless messages are directed to individuals that are most likely to be interested in their contents. The message content may also be formatted based upon captured information. For example, the message may contain information that is encoded using MIME encoding rules that are selected from amongst a plurality of MIME encoding rules based at least in part upon information such as the identity of the service provider with which the wireless device is associated, and/or a domain name associated with the user's wireless messaging address. The messaging address of the wireless device can be determined using captured information, such as the telephone number corresponding to the wireless device and the identity of the user's wireless service provider. Messages can be transmitted via the Internet, and/or using Short Messaging System services.

Messages transmitted according to the present invention may include links that can be accessed using a web browser. The user can then access the web browser link to retrieve further information through the service of web pages to the wireless device. Security features can be provided whereby the identity of the user is confirmed prior to transmission of such web pages. Quiz services can also be implemented, whereby the user is queried for responses to one or more questions. A feedback web page can be provided to the user, the contents of which are determined at least in part by the information received from the user in response to the quiz.

An apparatus implementing various messaging features is also provided. The system can include an interactive voice response unit connected to a telephone network through which a telephone call from a wireless device can be received. The interactive voice response unit can operate to capture a first set of data containing information conveyed by the wireless device. The system also includes a messaging subsystem operably connected to the interactive voice response unit. The messaging subsystem receives data from the interactive voice response unit, at least a portion of which is comprised of or derived from the information captured by the interactive voice response unit. The messaging subsystem operates to transmit digital messages to the wireless device.

The interactive voice response unit may include a caller identification mechanism capable of detecting a telephone number associated with the wireless device, which may be used for determination of a messaging address or verification of a user's identity. Messages can be transmitted using SMS services and/or the Internet. The messaging subsystem may include a MIME encoder operating to encode digital messages prior to their transmission to a wireless device. MIME encoding rules can be selected based upon information obtained from the interactive voice response unit, such as the wireless service provider with which a recipient is affiliated or the recipient's messaging address. The messaging subsystem may operate to transmit messages containing a web browser link that can be implemented by the wireless device. A web server can be provided to transmit one or more web pages to a wireless device in response to implementation of such a web browser link, thereby providing further messaging to the wireless device.

These and other aspects of the invention are further described herein.

### BRIEF DESCRIPTION OF THE DRAWINGS

FIG. 1 is a flowchart of a portion of the operation of a system for wireless opt-in data communications, in accordance with one embodiment of the present invention.

FIG. 2 is a flowchart of another portion of the operation of a system for wireless opt-in data communications, in accordance with one embodiment of the present invention.

FIG. 3 is a flowchart of yet another portion of the operation of a system for wireless opt-in data communications, in accordance with one embodiment of the present invention.

FIG. 4a is a block diagram of a first portion of a wireless communication system.

FIG. 4b is a block diagram of a second portion of a wireless communication system.

FIG. 5 is a flowchart illustrating a method of operation for a wireless communication system.

FIG. 6 is a flowchart illustrating the generation of a digital message.

FIG. 7 is a screenshot illustrating a user profile stored within a digital content server.

FIG. 8 is a screenshot illustrating configuration of a recipient group for digital messaging.

FIG. 9 is a screenshot illustrating association of a user profile with predetermined recipient groups.

FIG. 10 is a screenshot providing for creation of message content.

FIG. 11 is a screenshot illustrating a mechanism for identifying message recipients.

FIG. 12 is a flowchart illustrating a technique for transmitting messages.

FIG. 13 is a screenshot of a further message configuration utility.

FIG. 14 is a screenshot illustrating the creation of a web page.

FIG. 15 is a screenshot further illustrating the creation of a web page.

FIG. 16 is a screenshot illustrating the configuration of security settings.

FIG. 17 is a screenshot of a message configuration tool providing for transmission of messages with embedded graphic images.

FIG. 18 is a screenshot of a further configuration tool interface according to another aspect of the invention, providing for review of sent messages.

FIG. 19 is a screenshot illustrating the generation of hierarchical web pages.

FIG. 20 is a further screenshot illustrating the generation of hierarchical web pages.

FIG. 21 is a screenshot illustrating an interface for the development and transmission of interactive quizzes.

FIG. 22 is a screenshot indicating results from transmission of an interactive quiz.

FIG. 23 is a screenshot displaying a designated user's response to an interactive quiz.

FIG. 24 is a screenshot of an interface for adding user profiles to a digital content server.

FIG. 25 is a screenshot further indicating information within a user profile.

### DETAILED DESCRIPTION OF THE INVENTION

While this invention is susceptible of embodiment in many different forms, there are shown in the drawings and will herein be described in detail, certain specific embodiments with the understanding that the present disclosure should be considered as an exemplification of the principles of the invention and is not intended to limit the invention to the embodiments so illustrated.

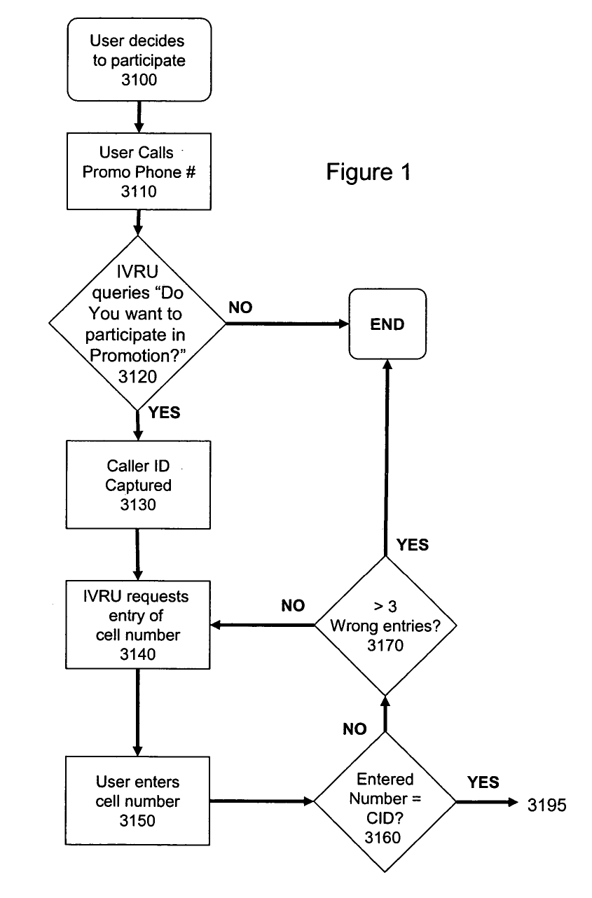

FIG. 1 is a flowchart of one embodiment of a system for the opt-in transmission of digital messaging, such as advertising and marketing materials, to users of wireless electronic devices such as cellular telephones. While certain aspects of the invention are illustrated in the context of transmitting messaging containing advertising and marketing materials, it is to be understood that the invention described herein can be readily and beneficially employed in a variety of contexts and applications beyond those specifically illustrated herein.

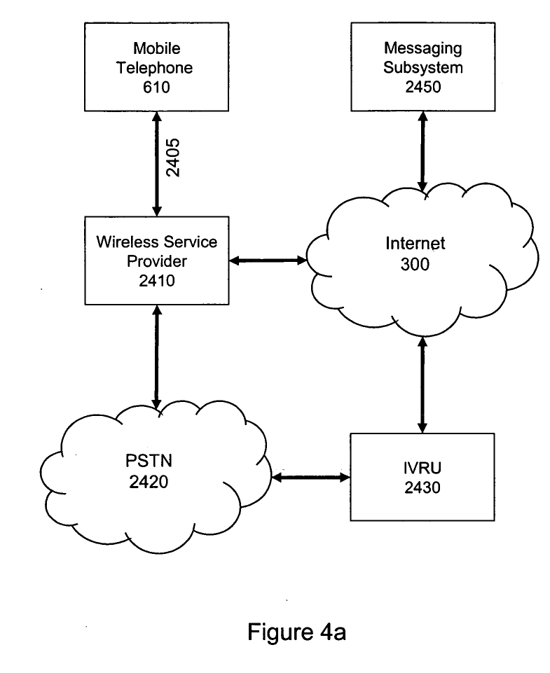

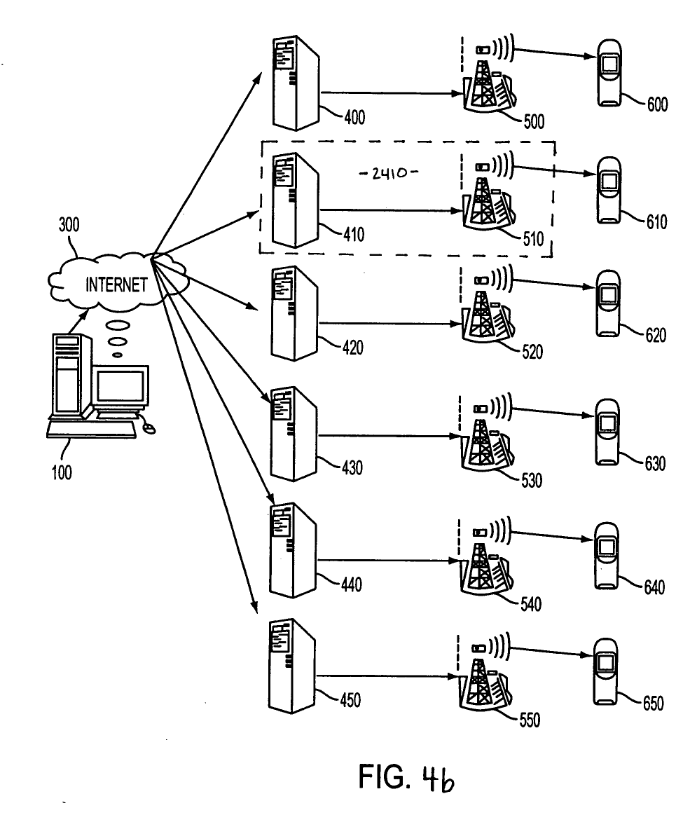

The system can be implemented in connection with a communications network configuration such as that depicted in FIG. 4a. FIG. 4a includes a user's mobile telephone 610, which communicates with wireless service provider 2410 via wireless communications link 2405. Wireless service provider 2410 supports connectivity with public switched telephone network 2420, through which telephone calls can be placed and received. Wireless service provider 2410 further supports connectivity with Internet 300, towards providing subscribers with data services such as email, SMS messaging, and web browsing. The system is further implemented using Interactive Voice Response Unit (IVRU) 2430, which is capable of receiving telephone calls from PSTN 2420, as well as conducting data communications via Internet 300. Finally, the system includes messaging subsystem 2450, which provides for the generation and transmission of digital messaging via Internet 300.

The system operation of FIG. 1 is initiated when a user decides to participate in a promotion, step 3100, whereby the user consents to allow the system operator to digitally transmit marketing or advertising materials to the user's wireless device. For example, this may occur in response to a user viewing a printed advertisement for a new product, offering to send the user additional information about the product following consent to receive wireless messaging from the advertiser. A discount coupon or chance to win a prize may also be offered towards further encouraging a user to participate.

After deciding to participate, the user calls a predetermined telephone number, step 3110. In so doing, mobile telephone 610 establishes a telephone connection with IVRU 2430 via wireless service provider 2410 and PSTN 2420. For example, a printed advertisement may indicate a toll-free number that can be called at any time to participate. Because participation is triggered by dialing a number on the public switched telephone network, an entity desiring to sponsor such a promotion need not coordinate the promotion with multiple wireless service providers. Rather, customers can access the system using a single common telephone number regardless of their service provider. Furthermore, setting up and maintaining a standard telephone number, even a toll-free number, may be less costly than setting up and maintaining a short code with multiple wireless service providers.

The telephone number dialed in step 3110 can be routed to a telephone system such as IVRU 2430, which is an automated electronic or software-driven system that gives callers the option to enter various types of information by, for example, pressing numbers and/or speaking. In step 3120, IVRU 2430 queries the user to confirm the user's desire to participate. For example, users can elect to receive a particular transmission of information, or they can consent generally to the receipt of information from the promotion sponsor. If the user does not desire to participate, the call is ended.

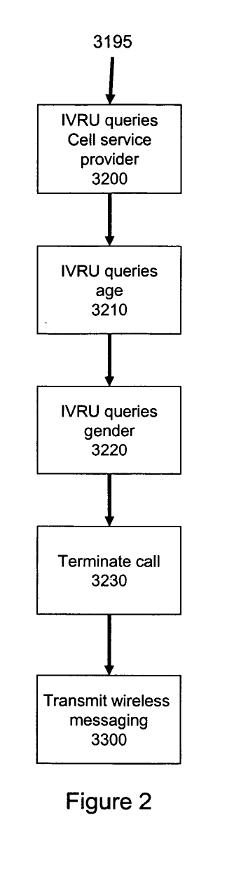

If the user desires to participate, the system of FIG. 1 operates to verify the identity of the caller, towards reducing the risk of a wireless phone user being opted-in to a promotion by others without consent. One technique for verifying the identity of the caller is by permitting a caller to opt-in to receipt of digital messaging on a wireless device only when the call in step 3110 is placed from the wireless device at which the digital messaging is to be received. Thus, in step 3130, the user's caller ID information, transmitted to IVRU 2430 from PSTN 2420 when the user places the call in step 3110, is captured and stored by IVRU 2430. Amongst the caller ID information is the calling telephone number. In step 140, IVRU 2430 queries the caller, requesting that the caller enter their wireless telephone number. The user enters a number in step 3150. In step 3160, the number entered in step 3150 is then compared to the caller ID information stored in step 3130. If the numbers match, the operation proceeds along branch 3195, to step 3200 in FIG. 2. If the numbers are not the same, IVRU 2430 checks whether an incorrect telephone number has been entered more than three times, step 3170. If not, IVRU 2430 returns to step 3140, again requesting entry of the caller's wireless telephone number, thereby permitting correction of the number in the event that the error results from misentry of the number in step 3150. If the wrong number is entered more than three times in step 3170, IVRU 2430 indicates to the user than registration for the promotional cannot proceed, and the call ends.

FIG. 2 illustrates further operation of the embodiment illustrated in FIG. 1. IVRU 2430 can be configured to query the user for additional information, such as information that can be used to customize the transmitted messaging and/or provide consumer demographic information to the promotion operator. In step 3200, IVRU 2430 queries the user to identify their wireless service provider. This information can be used, in part, to customize the formatting and/or content of the digital messaging sent to that user, as explained further below. For example, while wireless service providers generally implement certain messaging standards for their users, such as the SMS Short Messaging Service, their may remain differences in the ways in which messaging and information is formatted and transmitted by each of the wireless service providers. Thus, an SMS message that may appear aesthetically pleasing when conveyed to users of one wireless service provider, the message formatting may appear differently to a user of a different wireless service provider. By capturing the identity of the caller's wireless service provider, the formatting of subsequent messaging transmissions can optimized as desired for transmission by that user's wireless service provider.

The IVRU operation illustrated in FIG. 2 also captures certain user demographic information, for subsequent use in targeting marketing campaigns. In step 3210, IVRU 2430 queries the user's age. In step 3220, IVRU 2430 queries the user's gender. Once the information capture is complete, the system terminates the call, step 3230.

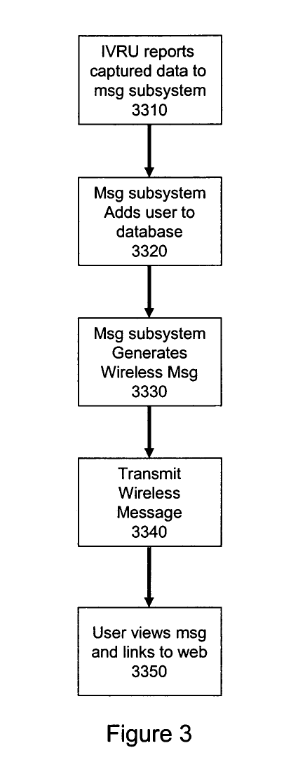

After the user's call is complete, the system can operate to transmit digital messaging to the caller's mobile telephone 610, step 3300. One embodiment of such a message transmission process is illustrated in the flowchart of FIG. 3. In step 3310, IVRU 2430 reports the captured information to messaging subsystem 2450 via Internet 300. In the embodiment illustrated in FIG. 4a, IVRU 2430 and messaging subsystem 2450 are separate subsystems. In such an embodiment, for example, a business sponsoring a promotion may operate IVRU 2430, while outsourcing messaging subsystem 2450 to a third party service provider. However, it is understood that in other embodiments, IVRU 2430 and messaging subsystem 2450 could readily be integrated on a common computing platform.

In step 3320, the information received from IVRU 2430 is added to a user database within messaging subsystem 2450. This may involve the generation of a user profile entry within a database, where at least some of the content stored within the user profile corresponds to information reported by IVRU 2430 in step 3310. In step 3330, messaging subsystem 2450 generates a digital message for transmission to one or more users. In accordance with one aspect of the invention, the digital message can optionally be comprised of a MIME-encoded message, transmitted to mobile telephone 610 using SMS services, that contains a link to a URL. The link can be activated by the user of mobile telephone 610 to automatically launch a wireless web browser, thereby providing access to further information.

In applications such as the system of FIGS. 1-3, a messaging subsystem may be called upon to transmit digital messaging to a wide variety of users, who may be using different brands and styles of wireless devices, having different display capabilities, communicating on different wireless networks operated by different wireless service providers. While certain standards are sometimes implemented to improve compatibility between different wireless platforms, differences remain which may impact the compatibility of wireless messaging, particularly with regard to the formatting and visual appearance of messages. Therefore, a messaging subsystem is described herein which provides for flexible digital messaging optionally having message content and formatting customized for each message recipient, based upon factors optionally including the identity of the wireless service provider and/or wireless device used by the recipient.

FIG. 4b illustrates another portion of the communication system illustrated in part by FIG. 4a, implementing certain other aspects of the present invention which may be employed to provide consistent and reliable digital messaging capabilities for communications with mobile telephone subscribers using different wireless platforms. The communication system implements advanced messaging functionality that is interoperable across a wide variety of wireless communication service providers, service standards, and subscriber hardware.

The communication system of FIG. 4b includes digital content server 100, which operates to implement messaging subsystem 2450 described above. Digital content server 100 can be configured to implement both MIME server and SMS server functionality, as well as other functionality. Digital content server 100 enables digital messaging with mobile telephones 600, 610, 620, 630, 640 and 650, which mobile telephones communicate with cellular networks 500, 510, 520, 530, 540 and 550, respectively. Of course, while the system of FIG. 4b is illustrated having mobile telephones 600-650 as subscriber devices, it is understood that other types of subscriber units (two-way pagers, PDAs, integrated telephone/PDAs, etc.) could also readily be employed. In the embodiment of FIG. 4b, each cellular network 500-550 is operated by a different wireless service provider. Each wireless service provider operates an SMS (Short Messaging System) server. Each of SMS servers 400, 410, 420, 430, 440 and 450 are capable of communicating with Internet 300, as well as the cellular networks with which they are associated. The SMS servers enable mobile telephone users to transmit and receive short digital messages, thus providing non-voice communication capabilities to mobile telephone users.

In addition to being configured for communication with their associated wireless networks, the SMS servers are configured for communication with Internet 300, in part through use of MIME formatting for digital content communicated thereon. Thus, the servers can receive messaging in a MIME format from Internet 300, allowing for transmission of email and other digital messaging from sources outside of the wireless network with which each proprietary SMS server is associated. Outbound digital content can be sent through a service provider MIME server (not shown) to enable MIME-enabled recipients to receive and properly decode digital content generated by mobile users.

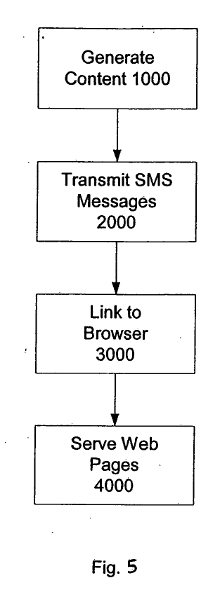

The flowchart of FIG. 5 illustrates one technique for the transmission of digital messaging using digital content server 100 according to another aspect of the invention. First, digital messaging content is generated in step 1000. Next, SMS messages are transmitted by digital content server 100, step 2000. The SMS messages are conveyed to mobile telephone subscribers, and may be used to invoke a subscriber's wireless web browser, step 3000. Finally, further messaging can be provided through service of digital content as web pages, step 4000.

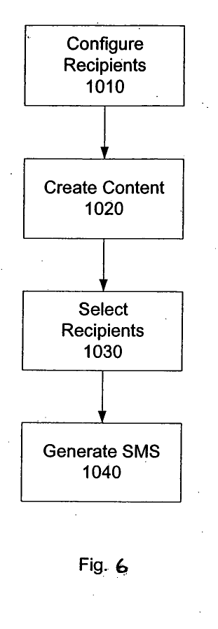

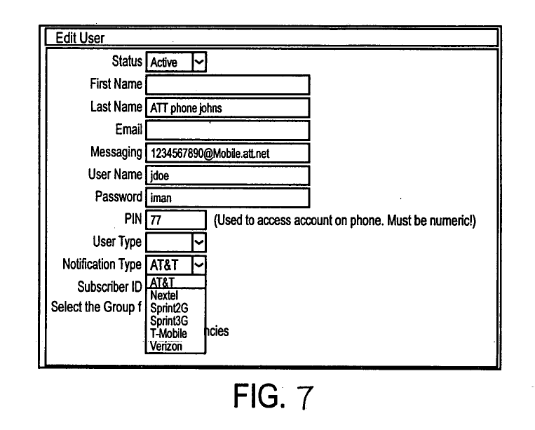

One embodiment of step 1000 for generating digital messaging content is further illustrated in the flowchart of FIG. 6. Initially, recipients are configured in step 1010. FIG. 7 illustrates a screen providing for the configuration of a message recipient via manual entry or editing of a database record. Fields are provided to store information regarding a user, including the user's name, email address, digital messaging address, user name, password, security PIN code, user type, notification type and subscriber ID. The user can be further designated as Active or Inactive.

In addition to allowing for manual configuration of recipients as illustrated in FIG. 7, information comprising a user profile can be captured by IVRU 2430 in accordance with the operation of FIGS. 1 and 2, and transferred from IVRU 2430 to messaging subsystem 2450 (implemented on content server 100), pursuant to step 3310 of FIG. 3. The information received from IVRU 2430 can then be used by content server 100 to automatically generate a user profile (step 3320, FIG. 3).

Information within the user profile can be captured directly by IVRU 2430, or derived from information captured by IVRU 2430. For example, a wireless service provider may implement a standardized format for a subscriber's messaging address, such as the user's wireless telephone number @ a predetermined domain name corresponding to the wireless service provider. By capturing the user's telephone number in step 3130 and/or step 3150, as well as the user's wireless service provider (step 3200), messaging subsystem 2450 may operate to automatically generate the user messaging address stored within the user's profile in step 3320 (FIG. 3) or step 1010 (FIG. 6).

A Notification Type designation can be stored within each user's profile and used to determine the formatting rules that are employed when messages to that user are encoded for transmission. Digital content server 100 is configured with information describing specific MIME formats used by various wireless service providers. By custom encoding user messages for the specific MIME formatting employed by the message recipient's wireless service provider, the user can be assured of reliably receiving digital messages having consistent and optimal layout and display of the message content. When a recipient profile is configured in step 1010, digital content server 100 can be configured to examine the domain name extension of the recipient's digital messaging address. If the domain name extension is recognized as being associated with a MIME format for which the digital content server is configured, the Notification Type corresponding to the address domain name extension is automatically selected.

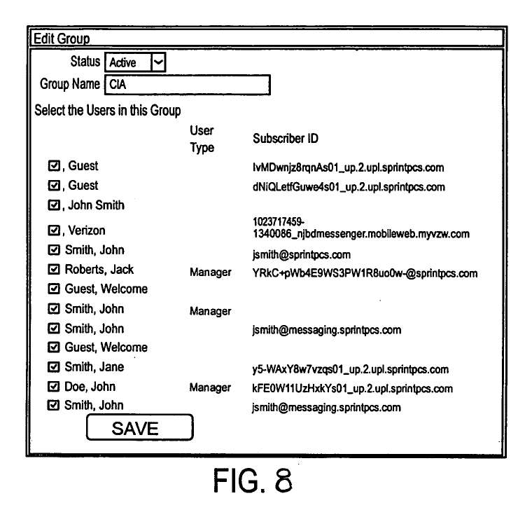

Content server 100 may also provide for configuration of recipient groups, allowing convenient preparation and transmission of digital messaging to predetermined sets of recipients. FIG. 8 illustrates a group configuration feature of content server 100, according to one aspect of the invention. A Group Name can be defined, and a plurality of users can be selected as group members. Furthermore, the entire group can be designated as Active or Inactive.

It may be desirable to automatically configure recipient groups within content server 100 based upon various criteria. For example, a group could be generated containing profiles for all individuals who called IVRU 2430 in connection with a particular promotion. Alternatively, recipient groups can be configured to contain all individuals having common demographic data collected in steps 3210 and 3220 (FIG. 2). Such groups can then be selected as recipients of targeting digital messaging, thereby enabling content server 100 to focus particular messages on recipients who are most likely to be interested in their content.

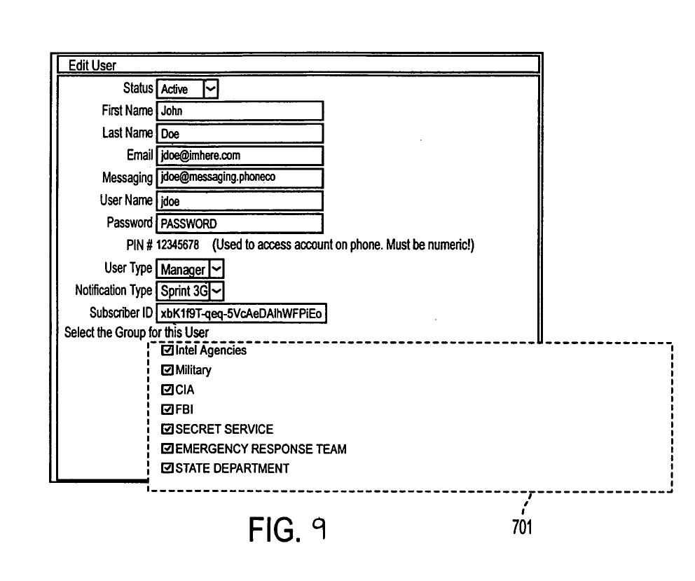

According to another aspect of the invention, group membership may also be configured on an individual recipient basis, via the recipient configuration screen of FIG. 9. A plurality of group names are displayed in region 701. The recipient can be included in, or excluded from, each group through selection or deselection of the check box associated with each group name.

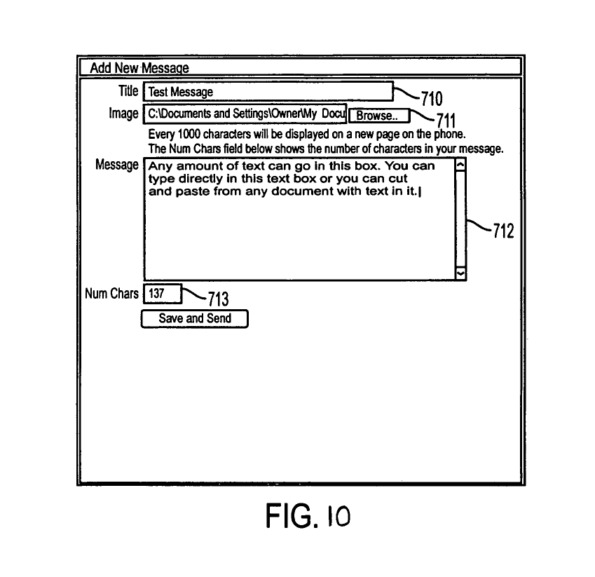

In step 1020 (FIG. 6), digital message content is created. A content creation mechanism according to one embodiment of the invention is illustrated in FIG. 10. The content creation screen of FIG. 10 supports both text and image content. Field 710 is provided for identification of a message title. Field 711 allows for the incorporation of image data into the message under composition. Finally, text content can be added to field 712, either via manual entry of the desired text or via automated cutting and pasting of content from other applications. Field 713 provides an automated count of the number of characters of text present within field 712, providing feedback regarding the size of the message that is being created. However, the size of the message entered into field 712 need not be restricted by a predetermined maximum length.

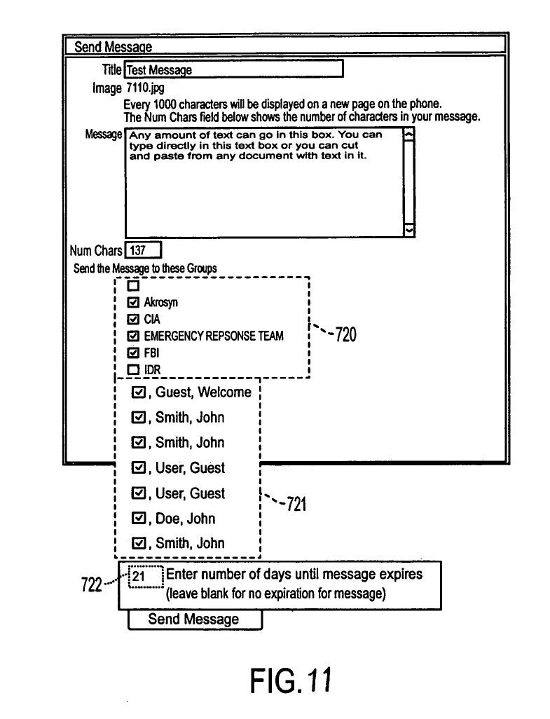

Once a message has been created, the message recipients can be identified, step 1030 (FIG. 6). The screen of FIG. 11 provides a mechanism for identifying recipients, according to another aspect of the invention. Predetermined groups of recipients can be selected using the group selection region 720. Also, individual recipients can be selected using the individual selection region 721.

According to yet another aspect of the invention, messages can be provided with various expiration options to provide a system administrator with enhanced control over message management. Typical prior art SMS servers are configured to maintain messages on the server for a predetermined period of time. However, field 722 allows for the determination of a message expiration period which can be individually set for each message that is composed. Thus, for example, important messages can be configured to be maintained for extended periods of time, while unimportant messages can be quickly deleted. This allows for optimal employment of server storage resources. Also, a read-once expiration option causes a message to be automatically deleted immediately after the message has been read. Such a read-once option may be useful for security purposes, towards ensuring that messages are destroyed after receipt and not unnecessarily available for unauthorized access.

Once recipients are selected, SMS messages are generated for each recipient, step 1040. Initially, a message is created for each recipient that includes a wireless web link that can be accessed by the recipient. The link generated for each recipient can be uniquely associated with the corresponding message content, thus enabling subsequent retrieval of message content by content server 100 when the recipient accesses the link. The formatting and content of the wireless web link sent to each user depends upon the MIME requirements of the service provider associated with the message recipient.

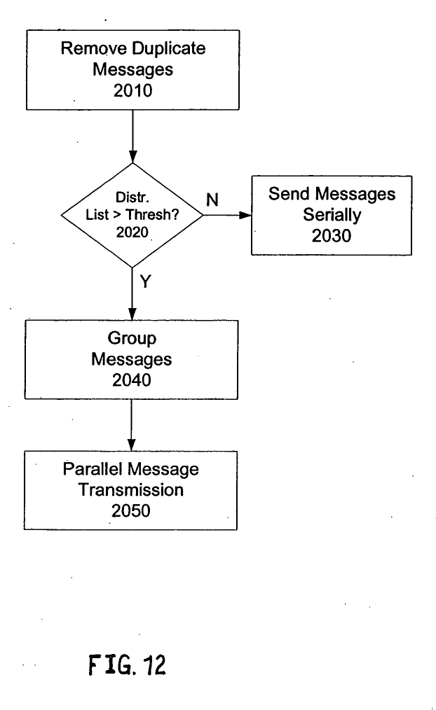

Once generated, the SMS messages are transmitted, step 2000 (FIG. 5). According to another aspect of the invention, a technique for transmitting the messages is illustrated in the flowchart of FIG. 12. Duplicate messages are removed in step 2010. Duplicate messages may be generated when a message identifies a particular individual recipient more than once, such as when a message is sent to a specific individual user as well as one or more groups of which that same user is a member. By searching for and removing duplicate messages in step 2010, care is taken to avoid transmission of the same message to a particular recipient more than once.

After any duplicate messages are removed, content server 100 evaluates the size of the message distribution list to determine a desired technique for sending the messages, step 2020. If the size of the distribution list is below a predetermined threshold (i.e. 10,000 users), then the load imposed on the server to transmit the messages is sufficient low that the messages can be rapidly and reliably transmitted in a serial fashion, step 2030. However, when the server requirements for transmitting the messages exceed a given threshold, alternate message transmission techniques can be employed (e.g. steps 2040 and 2050). In step 2040, messages are grouped for delivery based upon various attributes. For example, messages may be grouped by one or more of a variety of attributes, including by: the recipients' wireless service providers, alphabetically by recipient name, by title, geographic area, or any designation that may be captured within the user database. The messages can then be sent out in a parallel fashion by multiple servers, step 2050, whereby each grouping is routed to a different server. Such parallel transmission facilitates more rapid message transmission and potentially more efficient data routing.

Whether sent out serially by a single server, or in a parallel manner, the messages are routed via Internet 300 (FIG. 4b) to wireless service provider SMS servers 400-450. The messages are then conveyed via wireless service provider networks 500-550, to mobile phone users 600-650.

Once a SMS message is received by a subscriber's cellular telephone, the recipient can read the SMS message, thereby allowing the subscriber unit to automatically access a wireless Internet link, step 3000 (FIG. 5). The subscriber unit can then use integrated wireless web browser functionality to access the message content from digital content server 100 as a series of web pages, step 4000. Messaging content can be conveyed to the subscriber unit using WML (Wireless Markup Language). Alternatively, subscriber unit web browsers may utilize standards such as WAP (Wireless Application Protocol), WML (Wireless Markup Language), HDML (Handheld Device Markup Language) and/or XHTML (Extensible HyperText Markup Language) to display the messaging content.

Content server 100 converts the unlimited-length message contents, including text and optionally graphics, into a series of web pages that can be navigated by the subscriber. The web pages are then automatically served from content server 100. By providing messaging by using a recipient's web browser functionality rather than SMS, limitations on message length that are imposed by SMS messaging can be avoided. After a full web page of message text and/or graphics has been displayed to the subscriber, a “MORE” link is provided to initiate retrieval of the next of an arbitrary number of pages of message content, analogous to turning the pages of a book. Also, by utilizing web browser functionality of a subscriber device, images can be integrated with text in a common message.

According to another aspect of the invention, content server 100 can apply security features to its messaging. In creating a message, user authentication can optionally be required to assist in preventing unintended individuals from viewing the message contents. Content server 100 can store a subscriber ID corresponding to each user's wireless device, as well as a PIN code. The subscriber ID is typically used by wireless service providers for tracking network usage, maintaining billing records and sometimes for certain security purposes. The subscriber ID is typically a 12 digit alphanumeric code that is uniquely assigned to a given subscriber, and stored within the cellphone assigned to the subscriber.

A PIN code can also be stored within content server 100 and associated with each user. The PIN code is preferably a numeric code of approximately 10 digits in length. The PIN code can be assigned to each user by the administrator of content server 100.

Upon receiving a request to transmit message content, digital content server 100 examines the subscriber ID and the PIN code received from the requesting subscriber in conjunction with the request. If the subscriber ID and PIN code do not correspond to known values for a recipient of the requested message, then the message request is denied and no message content is transmitted.

An additional level of security can be provided by associating a password demand with a given message during the message configuration process. If a message is password protected, content server 100 initially returns a password query after the subscriber initiates the web link from the initial SMS message that is received by the subscriber. If the subscriber does not respond by providing the password associated with the subscriber, then access to the message contents is denied.

By using the Subscriber ID and PIN code for authentication, a user can readily upgrade subscriber hardware while maintaining the same service provider without causing an interruption in messaging service and without requiring manual intervention on the part of the operator of digital content server 100. This is because the Subscriber ID stays with the subscriber, and would be programmed into any new subscriber hardware to which a user may upgrade. Also, if a corporation or other entity provides wireless service for a subscriber, that subscriber will no longer be able to use the messaging system once the sponsoring organization closes an account, since the subscriber would receive a new Subscriber ID even when keeping the same cellphone and/or the same wireless service provider.

Also, the authentication procedures described herein prevents an unauthorized individual who learns of the PIN code and/or password of a messaging subscriber from accessing messages on digital content server 100 using a different subscriber unit, since the unauthorized user's Subscriber ID would not correspond to the Subscriber ID stored within content server 100. Also, when an account is designated INACTIVE within the Status field of the user configuration stored by content server 100, the associated Subscriber ID is blocked from accessing messaging and web-based content.

A final level of security can be provided on a link-by-link basis within a message having multiple links or menu options. In generating a message, various options and links can optionally be configured for access by only specified users. When transmitting the message content, content server 100 adapts the transmitting content based upon the content that is available to the requesting user. Thus, the subscriber unit of a user who is not authorized to access a particular link will not display the unauthorized link. An operator of content server 100 can dynamically maintain the list of authorized users for each link to control access to specific information at any given time. Additional security can be provided by implementing encryption techniques to encrypt the data that is transmitted between content server 100 and a wireless subscriber, towards preventing interception of transmitted information by unauthorized individuals.

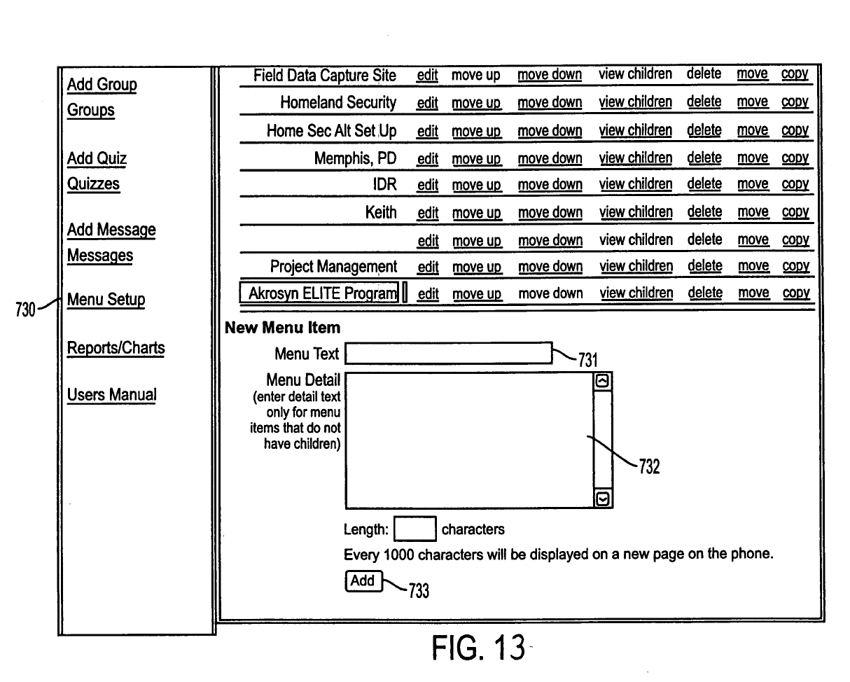

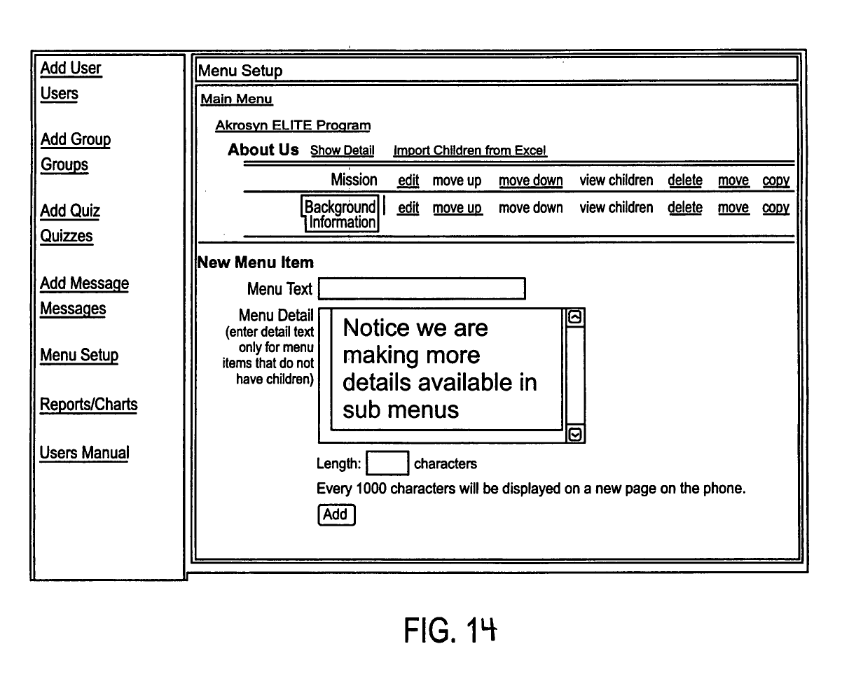

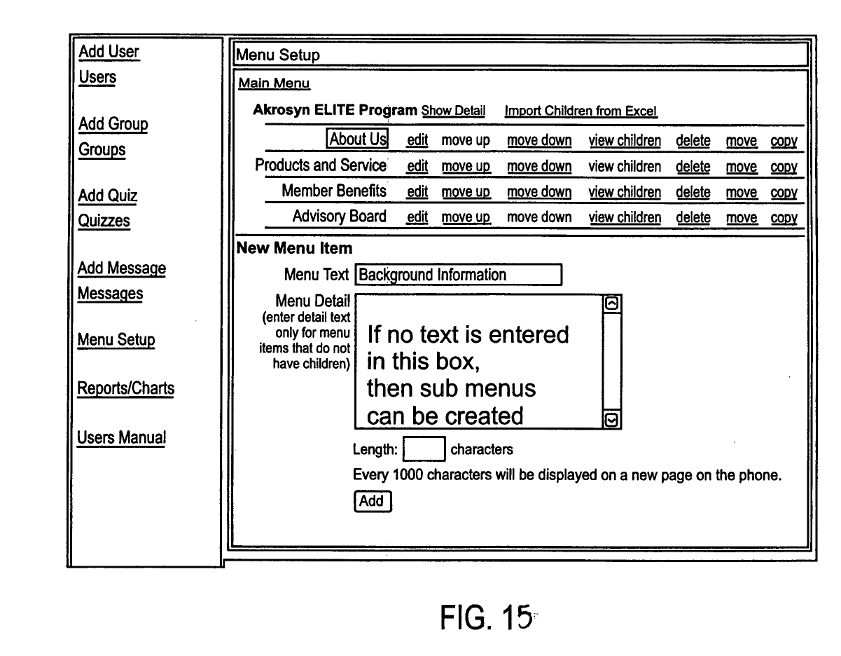

According to another aspect of the present invention, content server 100 also provides a software interface through which message content and wireless web pages can be quickly and easily configured. The interface provides for assembly of hierarchical information structures. For example, FIG. 13 illustrates one aspect of such a message configuration utility. After selecting “Menu Setup” option 730, an operator can enter the name of a menu selection in Menu Text field 731. Menu text labels can be configured in a hierarchical organization. At the lowest hierarchy levels, information can be provided in Menu Detail field 732. Information can be entered into Menu Detail field 732 manually, or by cutting and pasting content from other applications. Once a menu label or detail item is configured, Add button 733 can be selected to add the new item to the web page under construction. FIGS. 14 and 15 illustrate the creation of a web page using the configuration tool, having a top-level menu called “Akrosyn ELITE Program”, with four selections designated “About Us,” “Products and Services,” “Member Benefits,” and “Advisory Board.”

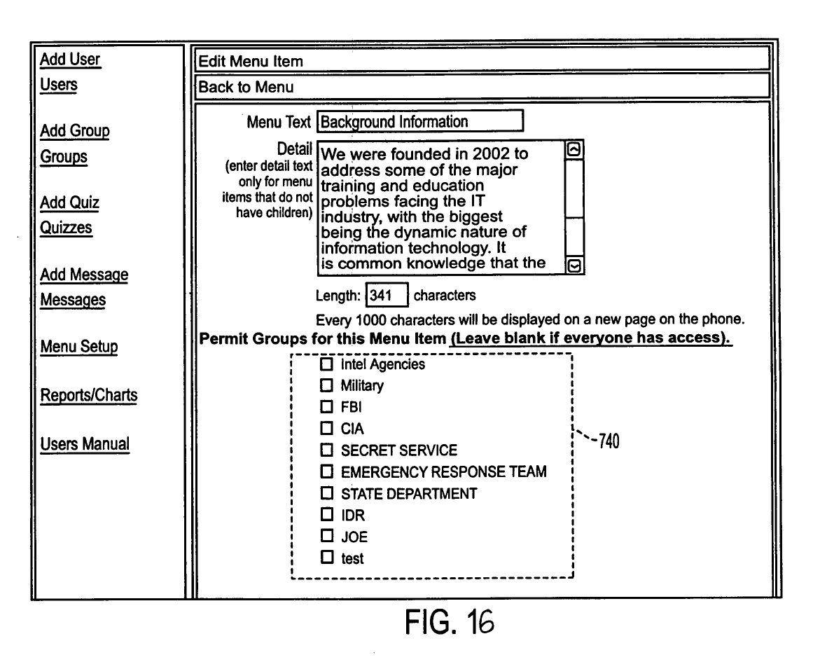

Security settings can be optionally applied to each menu item, through the interface of FIG. 16. Access to the selected menu item can be restricted to selected users and groups by selecting authorized users and/or groups within region 740. If no users or groups are selected, the menu item is available to all users.

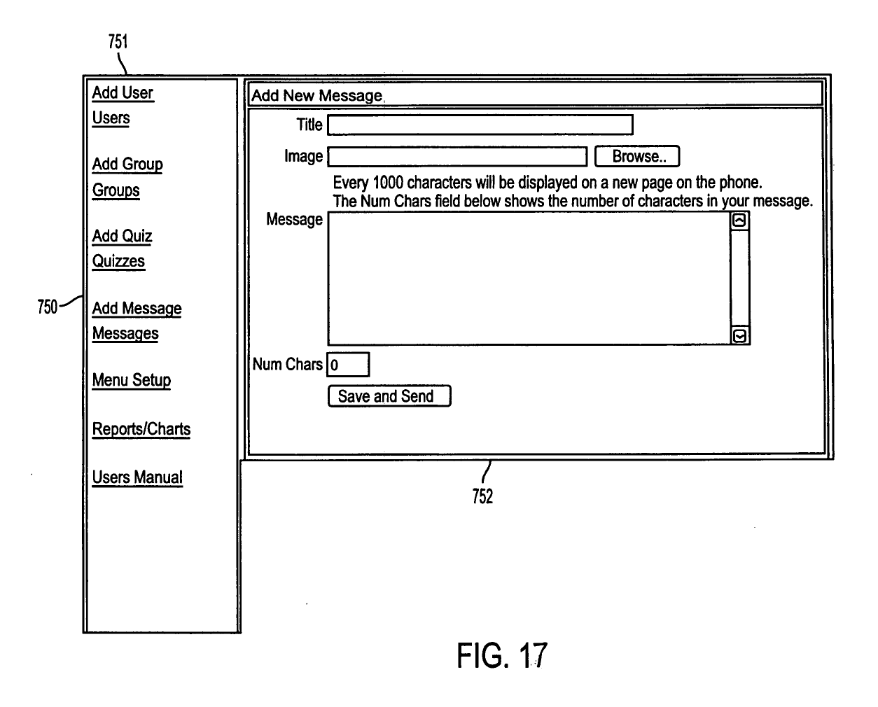

The message configuration tool also provides for transmission of messages with embedded graphic images through the interface illustrated in FIG. 17. Add Message selection 750 can be chosen from configuration tool selection bar 751, to initiate message configuration window 752. Window 752 can be used to create and transmit a message, as previously described.

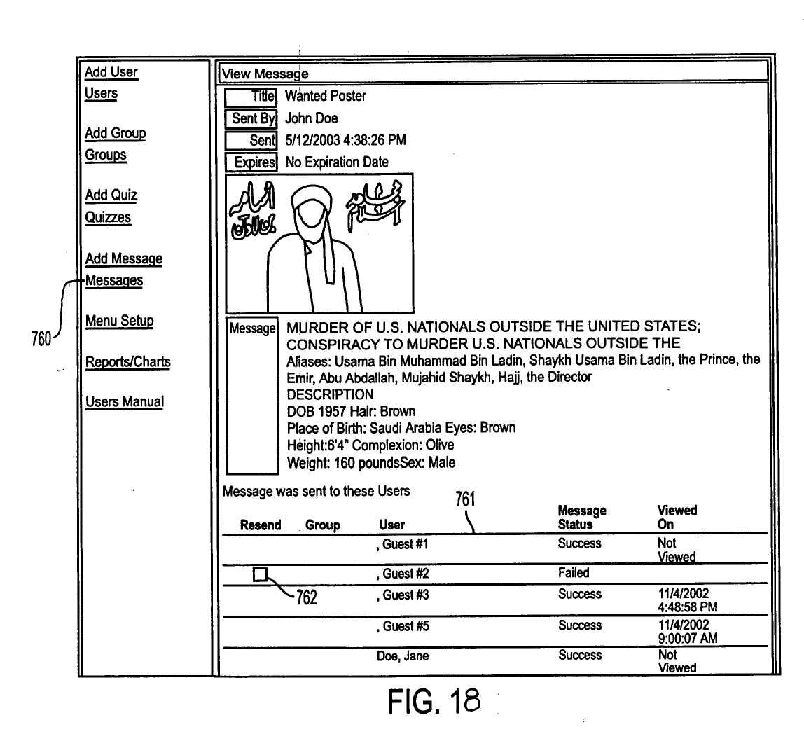

Sent messages can be reviewed by selecting “Messages” option 760 on the configuration tool interface of FIG. 18. Information regarding a sent message is displayed, including title, sender, date and time sent, expiration date and message contents. Also, region 761 identifies the status of delivery attempts for the displayed message. For each user name, information is provided indicating whether the message was successfully delivered, and if so, the date and time at which the message was viewed by the recipient, if at all. When message delivery fails, Resend selection item 762 is provided to initiate retransmission of the message to the associated user.

In accordance with another aspect of the invention, content server 100 can generate hierarchical web pages having both text and graphic images embedded within them. Such integration of unlimited text and graphics in a hierarchical data structure enables ready publication of information to users of wireless phones and like devices.

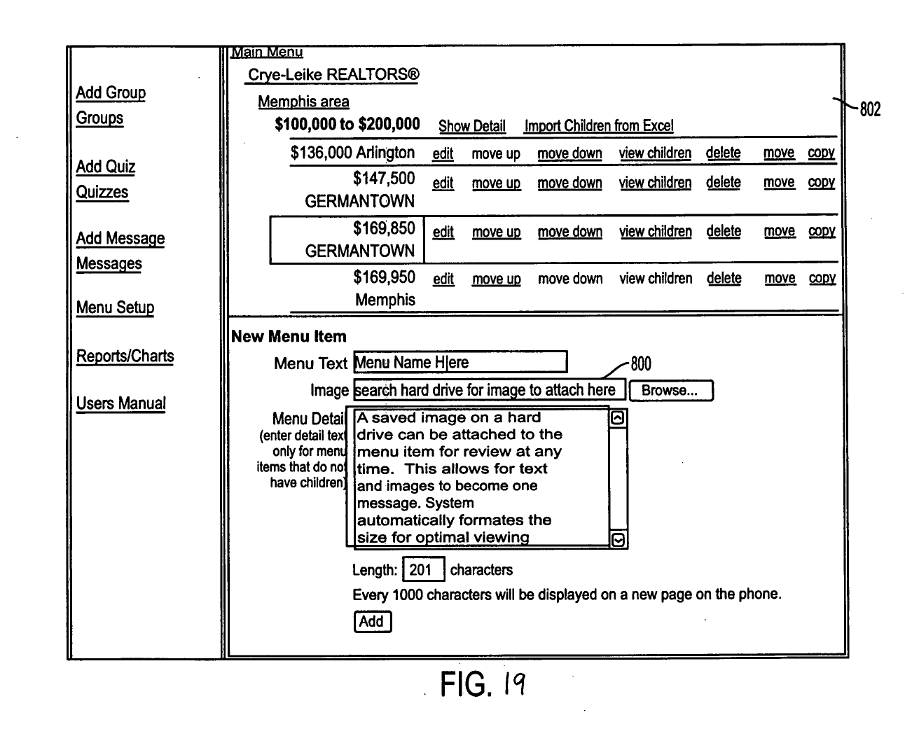

FIG. 19 illustrates the application of such a feature in the context of the wireless publication of real estate listings. In connection with one potential application of the present system, an individual seeking to purchase a new home may pass by a property having a sign advertising the offer of the property for sale, as well as a telephone number to call to receive additional information about the home, and optionally other similar homes, via wireless telephone. The telephone number may lead to IVRU 2450, operating in accordance with the description above. The system may then operate to transmit text and graphic messaging to the user created using an application such as that illustrated in FIG. 19.

A hierarchical publication, such as a set of real estate listings, can be created in a manner analogous to that of the text-based documents illustrated above. However, in FIG. 19, additional field 800 is provided, allowing for the selection of one or more graphic images to be associated with the menu item being defined. Thus, in region 802, a plurality of menu items are created, in which each menu item is associated with a property for which a real estate listing is available. A photograph of the property can then be associated with each real estate listing, enabling a potential buyer to view the property via a wireless telephone.

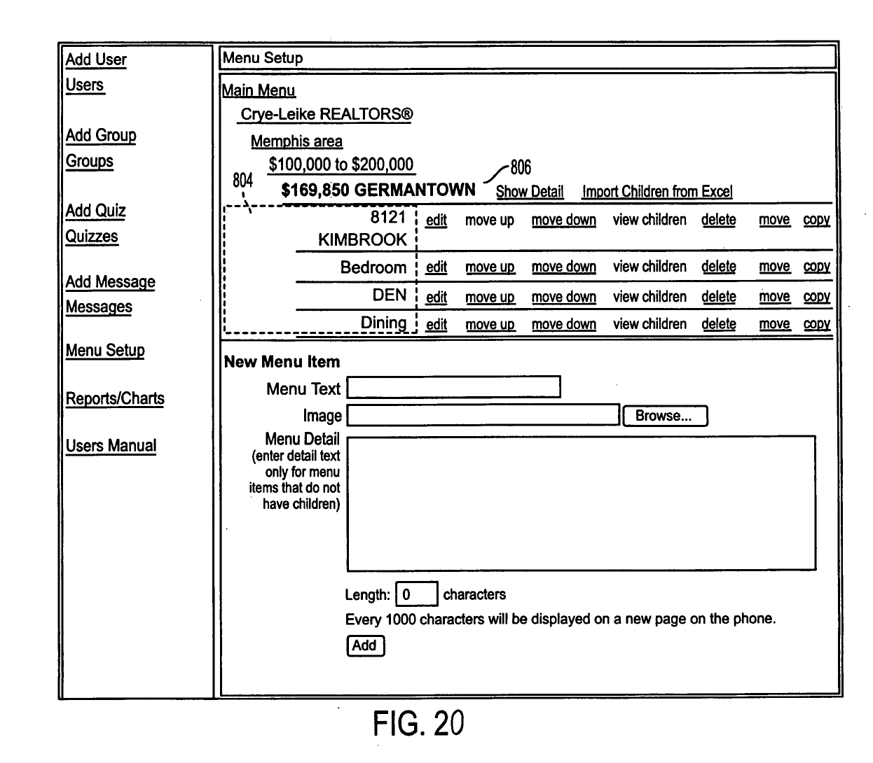

For each menu item (representing, in this case, a property listing), subsidiary menu items can be created beneath each property listing item, providing further information about the property. For example, in FIG. 20, additional sub-menu items are provided within region 804 indicating, for property listing 806, the street address of the listing, and various rooms within the house on the property. One or more graphic images can be associated with each room sub-menu item through use of field 800, providing a digital photograph of the room. Once created, the hierarchical web page with integrated graphics and images can be navigated by a wireless telephone or like device. In addition to real estate listings, such web pages can be used to publish other types of documents and/or information, including magazine articles with photos and/or diagrams, to users of cellular telephones.

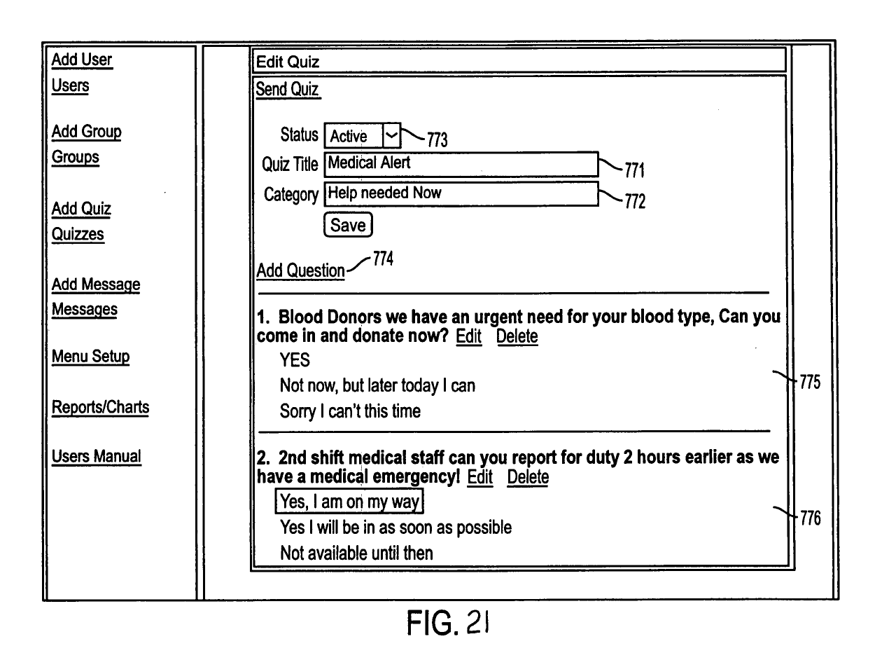

According to another aspect of the invention, the message configuration tool can also be used to develop and transmit interactive quizzes to users via the interface of FIG. 21. Option 770 can be selected in the configuration tool selection bar to generate a new quiz message. The Quiz Title and Category are entered in fields 771 and 772, respectively. The quiz can be designated as Active or Inactive via Status field 773. Region 774 can be selected to add a question to the quiz under development. For each question, multiple possible answers can be specified. Examples of quiz questions are illustrated in regions 775 and 776. Once a quiz question is designed, it can be transmitted analogously to the messages providing text and/or graphics, discussed above. However, when a subscriber receives and activates a SMS link, the recipient's subscriber unit retrieves web pages displaying the quiz questions and requesting responses from the recipient.

Responses to quiz questions are received and tabulated by content server 100. Optionally, a message can be sent to the quiz recipient after the recipient's responses are received, towards providing feedback to the user regarding his or her answers. For example, in the case of an opinion poll, content server 100 can transmit a web page to the user indicating a summary of answers received by other users. If the quiz questions are objective, having correct and incorrect answers, content server 100 can transmit a web page to the user indicating what the correct answers were, and how many questions were answered correctly and/or incorrectly.

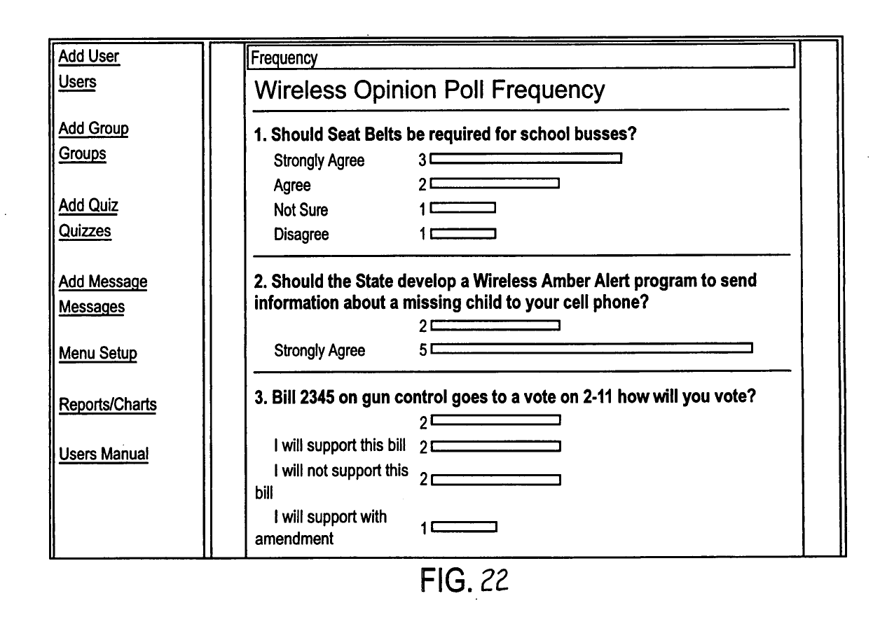

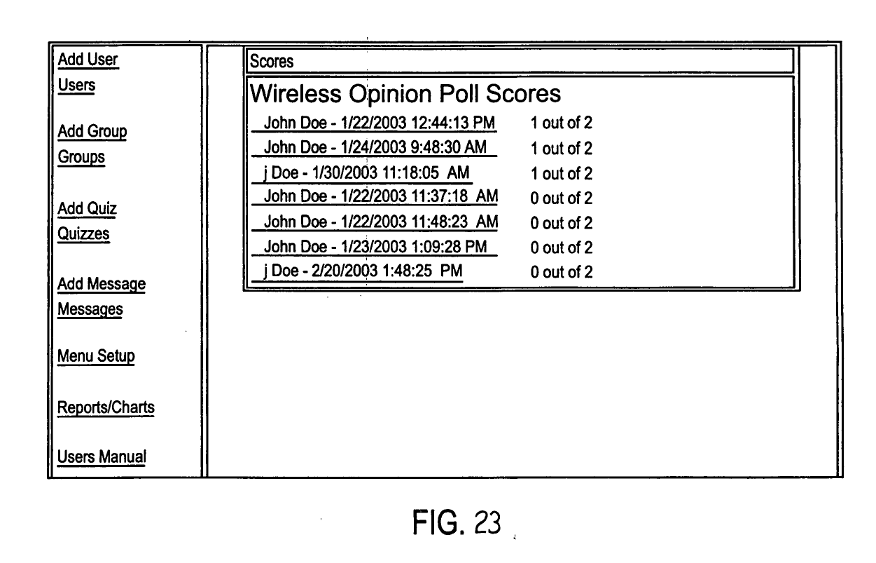

Content server 100 also provides an interface by which quiz results can be analyzed. FIG. 22 illustrates a display indicating the responses received for each quiz. Also, FIG. 23 illustrates a display whereby a designated user's specific quiz answers can be displayed.

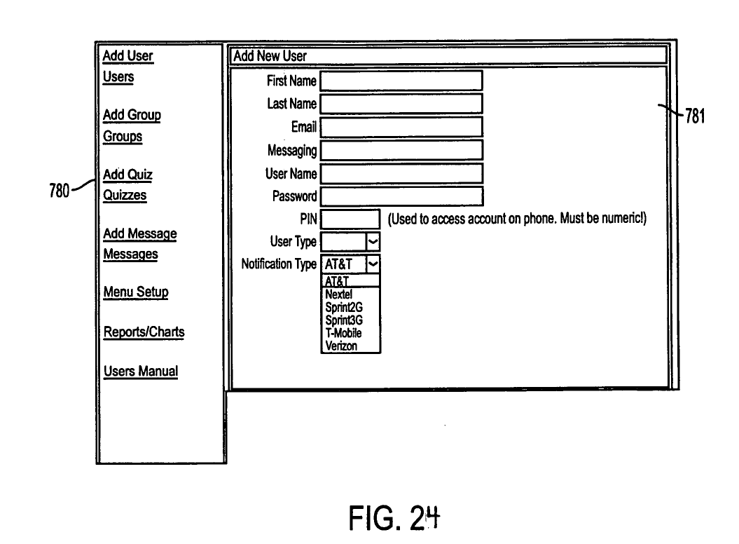

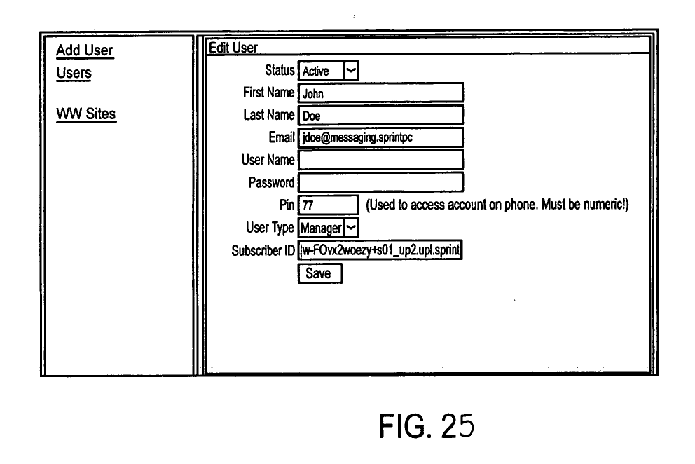

According to another aspect of the invention, the message configuration tool also provides an interface to add new users to the system, illustrated in FIG. 24. The addition of a new user is initiated through selection of item 780 within the configuration tool selection bar. User information is entered into fields within region 781, as described previously in connection with FIGS. 7-9. Once a user accesses content server 100 for the first time, the user's Subscriber ID is captured and populated within a content server database. The Subscriber ID and other security information can subsequently be viewed and edited through the interface of FIG. 25.

The foregoing description and drawings merely explain and illustrate the invention and the invention is not limited thereto, inasmuch as those skilled in the art, having the present disclosure before them will be able to make modifications and variations therein without departing from the scope of the invention.

I claim:

1. A method for transmitting digital messaging to a user of a wireless electronic device, the method comprising the steps of:
receiving a telephone call placed using the wireless electronic device;
capturing a set of information associated with the wireless electronic device and/or the user;
transmitting one or more digital messages to the wireless electronic device.

2. The method of claim 1, in which the step of capturing information associated with the wireless electronic device and/or the user is further comprised of the substep of detecting a telephone number associated with the wireless electronic device using caller identification services.

3. The method of claim 1, in which the step of capturing information associated with the wireless electronic device and/or the user is further comprised of the substeps of:
prompting the user for entry of a telephone number associated with the wireless electronic device; and
detecting a telephone number entered by the user.

4. The method of claim 1, in which the step of capturing a set of information associated with the wireless electronic device and/or the user is further comprised of the substeps of:
detecting a first telephone number associated with the wireless electronic device using caller identification services;
prompting the user for entry of a telephone number associated with the wireless electronic device; and
detecting a second telephone number entered by the user;
including one or more of the first telephone number and the second telephone number within the set of information if the first telephone number matches the second telephone number.

5. The method of claim 1, in which the set of information comprises the age of the user and the gender of the user; and the method further comprises the step of storing the set of information within a database.

6. The method of claim 1, in which the set of information comprises a telephone number associated with the wireless electronic device and the identity of a wireless service provider associated with the wireless electronic device.

7. The method of claim 6, in which the one or more digital messages transmitted to the wireless electronic device comprise content that is dependent upon the contents of the set of information.

8. The method of claim 6, in which the step of transmitting one or more digital messages to the wireless electronic device is comprised of the substeps of:
generating message content;
encoding the message content using MIME encoding rules selected from amongst a plurality of MIME encoding rules based at least in part upon information contained within the set of information;
transmitting the encoded message content to the wireless device.

9. The method of claim 8, in which the step of encoding the message content is further comprised of the substeps of:
selecting one of a plurality of predetermined notification types based at least in part upon information contained within the set of information;
encoding the message content using MIME encoding rules selected from amongst a plurality of MIME encoding rules based at least in part upon the selected notification type.

10. The method of claim 8, in which the step of transmitting the encoded message content to the wireless device is further comprised of the substeps of:
identifying a user address for the wireless device based at least in part upon information contained within the set of information;
transmitting the encoded message content to the user address.

11. The method of claim 9, in which the step of selecting one of a plurality of predetermined notification types is further comprised of the substep of selecting a notification type based upon the identity of the wireless service provider associated with the wireless device.

12. The method of claim 9, in which the step of selecting one of a plurality of predetermined notification types is further comprised of the substep of selecting a notification type based upon a domain name with which the user address is associated.

13. The method of claim 10, in which the substep of transmitting the encoded message content to the user address is comprised of the substep of transmitting the encoded message content to the user address via the Internet.

14. The method of claim 8, in which the substep of transmitting the encoded message content is comprised of the substep of transmitting the encoded message content via a Short Messaging System protocol implemented by the wireless service provider associated with the wireless device to which the message is directed.

15. The method of claim 13, in which the message content includes a web browser link that can be accessed by the wireless device to retrieve further information using a web browser implemented within the wireless device.

16. The method of claim 15, in which the substep of transmitting the encoded message content to the user address via the Internet is performed by a first server;
the method further comprising the step of transmitting by the first server one or more web pages to the wireless device in response to accessing by the wireless device of the web browser link.

17. The method of claim 16, in which the step of transmitting by the first server one or more web pages to the wireless device is comprised of the substeps of:
verifying the identity of the user implementing the web browser link; and
transmitting one or more web pages to the wireless device if and only if the identity of the user is verified.

18. The method of claim 16, in which the one or more web pages comprise a quiz requesting information from the user, the method further comprising the steps of:
receiving the information from the user in response to the quiz;
transmitting a feedback web page to the user, the contents of which are determined at least in part by the information received from the user in response to the quiz.

19. A system for transmitting information to a mobile electronic device capable of wireless communications, the system comprising:
an interactive voice response unit having a first communication link connected to a telephone network through which the unit operates to receive a telephone call from a wireless device and to capture a first set of data containing information conveyed by the wireless device;
a messaging subsystem operably connected to the interactive voice response unit for receiving a second set of data, at least a portion of which is comprised of or derived from the first set of data, and which messaging subsystem is capable of transmitting a digital message to the wireless device.

20. The system of claim 19, in which the interactive voice response unit further comprises a caller identification detection mechanism capable of detecting a telephone number associated with the wireless device; and
the first set of data comprises the telephone number detected by the caller identification mechanism.

21. The system of claim 20, in which the messaging subsystem is configured to transmit digital messaging to a wireless device using SMS services.

22. The system of claim 21, in which the messaging subsystem is configured to determine a messaging address corresponding to the wireless device using at least a portion of the first set of data.

23. The system of claim 20, in which the interactive voice response unit is further configured to prompt for the entry of a telephone number associated with the wireless device; and in which the messaging subsystem is configured to transmit digital messaging to the wireless device only following a successful comparison of a telephone number entered in response to a query by the interactive voice response unit, to the telephone number detected by the caller identification detection mechanism.

24. The system of claim 19, in which the first set of data comprises the age of a user associated with the wireless device.

25. The system of claim 19, in which the first set of data comprises the gender of a user of the wireless device.

26. The system of claim 19, in which the first set of data comprises an identifier corresponding to a wireless service provider with which the wireless device is affiliated.

27. The system of claim 19, in which the digital message is comprised of content that is dependent at least in part upon the contents of the first set of information.

28. The system of claim 19, in which the messaging subsystem further comprises a MIME encoder operating to encode the digital message prior to the transmission of the digital message to the wireless device, using MIME encoding rules selected from amongst a plurality of MIME encoding rules based at least in part upon the contents of the first set of information.

29. The system of claim 26, further comprising a MIME encoder operating to encode the digital message prior to the transmission of the digital message to the wireless device, using MIME encoding rules selected from amongst a plurality of MIME encoding rules based at least in part upon the identifier corresponding to a wireless service provider with which the wireless device is affiliated

30. The system of claim 19, further comprising a MIME encoder operating to encode the digital message prior to the transmission of the digital message to the wireless device, using MIME encoding rules selected from amongst a plurality of MIME encoding rules based at least in part upon the contents of a messaging address corresponding to the wireless device.

31. The system of claim 19, in which the digital message is comprised of a web browser link that can be implemented by the wireless device to which the message is transmitted.

32. The system of claim 31, further comprising a web server operating to transmit one or more web pages to the wireless device in response to implementation of the web browser link.
